(19) United States
(12) Patent Application Publication
(10) Pub. No.: US 2026/0170035 A1
(43) Pub. Date: Jun. 18, 2026

(54) COMPUTING CLOUD ASSET RELATIONSHIPS USING VECTOR EMBEDDINGS

(71) Applicant: Palo Alto Networks, Inc., Santa Clara, CA (US)

(72) Inventors: Vivek Hari Menon, Kerala (IN); Kunyalik Garg, Patna (IN); Vaibhav Tomar, Budaun (IN)

(21) Appl. No.: 18/984,728

(22) Filed: Dec. 17, 2024

(51) Int. Cl. G06F 16/334; G06F 16/332

(52) U.S. Cl. CPC G06F 16/3346; G06F 16/3326

(57) ABSTRACT

Various techniques for computing cloud asset relationships using vector embeddings are disclosed. In some embodiments, a system, process, and/or computer program product for computing cloud asset relationships using vector embeddings includes ingesting metadata associated with a plurality of assets of a cloud computing infrastructure for an entity and a cloud service provider (CSP) specification into a security service, generating a dataset by collating the metadata associated with each of the plurality of assets and data of the CSP specification(s), generating embeddings of the dataset using a machine learning model; and determining relationships between the plurality of assets based at least in part on the embeddings and a similarity score.

### BACKGROUND OF THE INVENTION

Entities maintain cloud computing infrastructures with a plurality of separate assets. Pluralities of assets may have relationships between each other, such as communications between one or more assets. Understanding these relationships may provide the entity with valuable insights regarding their cloud computing infrastructure. Cloud computing infrastructure may be complex and ever-changing.

### BRIEF DESCRIPTION OF THE DRAWINGS

Various embodiments of the invention are disclosed in the following detailed description and the accompanying drawings.

FIG. 1 is a system diagram for identifying the relationships between a cloud computing infrastructure's assets using an embedding model in accordance with some embodiments.

FIG. 2 is a process diagram illustrating a process for determining relationships between a cloud computing infrastructure's assets using an embedding model in accordance with some embodiments.

FIG. 3 is a process diagram illustrating a process for determining the relationships for an asset in accordance with some embodiments.

FIG. 4 is a process diagram illustrating a process for determining the relationship between a set of assets in accordance with some embodiments.

FIG. 5 is an example of an ingested metadata in accordance with some embodiments.

FIG. 6 is an example of a collated dataset in accordance with some embodiments.

FIG. 7 is an example of asset relationship metadata in accordance with some embodiments.

FIG. 8 is an example of an attack on a cloud computing infrastructure.

FIG. 9 is a process diagram illustrating a process for making security recommendations regarding cloud computing infrastructure in accordance with some embodiments.

FIG. 10 is an example of a visual representation of a cloud computing infrastructure in accordance with some embodiments.

FIG. 11 is an example of training data for use in a fine-tuning procedure in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various techniques for rapidly identifying relationships between assets in cloud computing infrastructure are disclosed herein. Metadata associated with a plurality of assets and cloud service provider (CSP) configurations are ingested by a security service (e.g., a cloud security service (CSS)). A collated dataset representing the metadata and CSP specification(s) data is generated. Embeddings of the collated dataset are generated using a machine learning (ML) model (e.g., a vector-based embedding model, such as will be further described herein). Relationships between the plurality of assets are determined using the embeddings.

Entities (e.g., including enterprise users associated with various types of entities, such as public/private companies, educational entities, government entities, etc.) may use cloud computing infrastructure to provide various computing related services. For example, a social media company may deploy cloud computing infrastructure to maintain a social media application. An entity's cloud computing infrastructure may contain a plurality of assets. Often the number of separate assets is large. For example, a social media company may maintain one or more compute instances to serve an application, a load balance instance to distribute application traffic between a plurality of compute instances, one or more logging instances to log cloud activities, one or more database instances to store user data, one or more authentication instances to authenticate users, an instance to manage data pipelines, etc. As another example, an enterprise may use cloud computing infrastructure for the information technology computing infrastructure for the enterprise in lieu of or in a hybrid deployment with on premises computing infrastructure for the enterprise.

Assets may be related to each other by a variety of means, such as shared attributes or available communication links. Assets may be related to each other through other assets. An example of a mechanism that can relate assets through communications is Application Program Interfaces (APIs). To illustrate, an authentication asset may be related to a database asset by an API that facilitates the retrieval of user information when the authentication asset authenticates a user. Assets may also be related to each other through shared attributes. As an illustration, a storage asset and a virtual machine (VM) asset may use the same authentication attribute, such as a token. A party with access to the VM may be able to access the storage asset by viewing the token. Assets may be related through shared data, communication, or any method.

As entities' cloud computing infrastructure grows, it becomes increasingly difficult to understand how assets relate to each other. This technical challenge is made more difficult due to the complex, voluminous, and mercurial cloud computing infrastructure documentation provided by cloud service providers (CSPs) (e.g., referred to herein generally as a CSP specification(s)). Often times entities are not fully aware of the relationships between assets as dictated in an example CSP specification(s). Currently, entities employ human resources, such as network researchers, to manually identify the relationship between cloud assets. This process is time consuming (e.g., may require weeks of manual analysis by IT/networking/security personnel) and error prone.

As such, new and improved techniques are needed for providing an effective and efficient solution for identifying such relationships between cloud assets in various cloud computing infrastructure environments.

Accordingly, various techniques disclosed herein facilitate an automated solution for effectively and efficiently identifying relationships between cloud assets (e.g., in minutes or hours as compared with weeks required to perform such manually). Further, the ML-based techniques disclosed herein can automatically adapt to changing (e.g., growing, modifying, shrinking, configuration changes to a given enterprise's cloud computing environment, etc.) cloud computing infrastructure(s) and changing CSP specification(s) for various cloud service providers (CSPs).

Effectively and efficiently identifying asset relationships can be desirable for a number of reasons. First, identifying certain asset relationships in a given cloud computing environment and configuration can expose attack vectors. For example, it is desirable for a social media company to know which cloud assets can be used by an attacker to access sensitive user data on a database asset in their cloud computing environment. Second, when an entity is exposed to a data breach or security incident, visibility into how this can impact other assets is desirable. In another example, it can be useful for a cloud-based startup to understand how its compute resources are being used for budgeting purposes (e.g., to determine what assets are crucial for the company's function).

The disclosed techniques employ a machine learning (ML) model using vector embeddings to facilitate automatically identifying relationships between cloud assets. Metadata of an entity's cloud computing infrastructure is acquired. The metadata describes the cloud computing infrastructure. In some embodiments, the metadata includes information that indicates the presence of each asset. In some embodiments, the metadata includes further details associated with the asset. The metadata may provide information that directly leads to further information about each asset. For example, an asset's metadata may contain CSP API calls that return the CSP's configuration and/or documentation for the particular asset. The CSP's configuration and/or documentation for the asset can also be acquired using one or more defining attributes of the asset. A defining attribute of the asset may indicate what the asset is. For example, if the CSP is Amazon Web Services™ (AWS), a defining attribute may be aws-ecs-cluster which indicates that the asset is an EC2™ cluster. The CSP specification(s) and/or documentation and the defining attributes of the assets are collated into a collated dataset. The collated dataset collates defining attributes to definitional information pertaining to the asset such as one or more associated attributes (e.g., API calls, commands, variables, etc.) and the description of the one or more attributes as provided by CSP specification(s) and/or documentation.

An ML model is used to generate embeddings (e.g., vector embeddings) that represent attributes within the collated dataset, including the defining attribute. In some embodiments, the ML model comprises a base embedding model that is fine-tuned using various cloud computing infrastructure metadata and/or other relevant data. The association between the defining attributes and their embeddings is captured using the base embedding model, such as will be further described below. A similarity between a single asset and each of the other assets can be determined by comparing the embeddings of the single asset to the embeddings of all other assets. The similarity between all assets to all other assets can be used to establish the relationships between each asset. This enables the cloud computing infrastructure to be described as a plurality of assets and their relationships to facilitate an effective and efficient solution for automatically identifying computing cloud computing infrastructure asset relationships using vector embeddings as will be further described below with respect to various embodiments.

The disclosed techniques also allow an entity to identify the relationships between a plurality of cloud assets. For example, identifying the relationships between a plurality of cloud assets is valuable for managing and protecting cloud computing infrastructure. However, it can be costly and difficult to determine these relationships as similarly described above. As such, disclosed techniques automate the identification of the relationships between a plurality of cloud assets, thereby greatly reducing the cost and difficulty associated with identifying relationships in cloud computing infrastructures. Furthermore, the techniques can assist entities to respond to rapidly growing cloud computing infrastructures and mercurial CSP specification(s). Additionally, the disclosed techniques can be configured to determine asset relationships of a cloud computing infrastructure across different CSP cloud computing infrastructures and associated configurations.

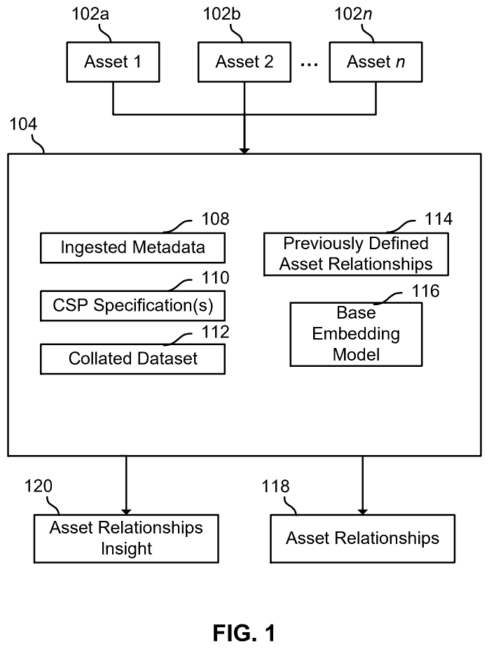

FIG. 1 is a system diagram for identifying the relationships between a cloud computing infrastructure's assets using an embedding model in accordance with some embodiments. In this example, an entity (e.g., company, government, institution, etc.) maintains cloud computing infrastructure with assets 102a, 102b, . . . 102n and associated configuration settings (e.g., configurations). The cloud user utilizes security service 104 (e.g., a cloud security service (CSS)) to receive asset relationship insights 120. In some embodiments, security service 104 generates a definition of assets 102a, 102b, . . . 102n using ingested metadata 108. In some embodiments, security service 104 uses ingested metadata 108 to generate/modify/supplement CSP specification(s) 110. In some embodiments, security service 104 combines ingested metadata 108 with CSP specification(s) 110 to generate a collated dataset 112. In some embodiments, security service 104 fine-tunes base embedding model 116 with previously defined asset relationships 114, creating a fine-tuned embedding model, such as will be further described herein. In some embodiments, security service 104 generates embeddings (e.g., vector embeddings) based on collated dataset 112 using the fine-tuned embedding model (116). Asset relationships 118 can be automatically generated using the embeddings. Using asset relationships 118, security service 104 can also automatically generate asset relationship insights 120 using the embeddings.

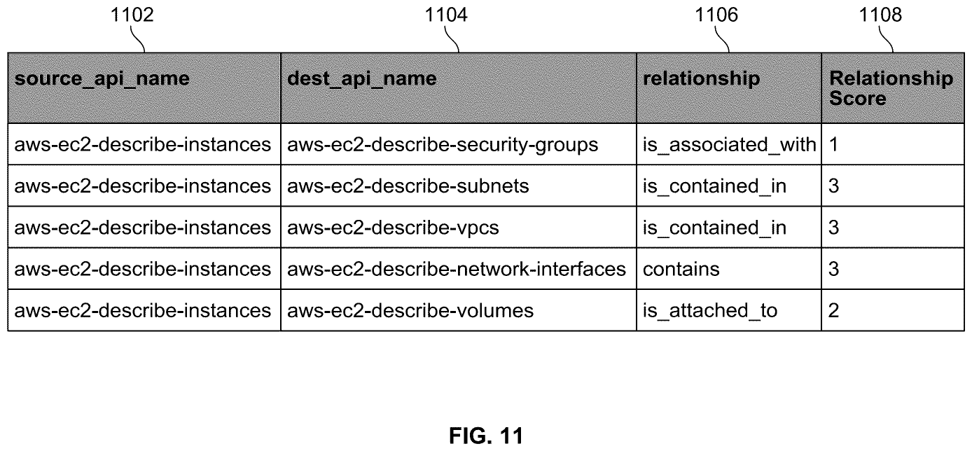

In an example implementation, base embedding model 116 can be implemented using a procedure to fine-tune base embedding model 116 is described below. Examples of implementations of base embedding models include Textembedding-gecko™, BERT, ROBERTa, T5, DistilBERT, Sentence-BERT, DeBERTa, SimCSE, etc. The base embedding model can be fine-tuned using the fine-tuning procedure described further below with respect to FIG. 11.

In this example implementation, security service 104 provides the cloud user associated with assets 102a, 102b, . . . 102n with asset relationship insights 120. For example, asset relationship insights 120 may be used by the cloud user to better understand their cloud computing infrastructure and/or to prevent attacks on their cloud computing infrastructure.

Assets 102a, 102b, . . . , 102n may be any cloud asset of any CSP (e.g., AWS, Google Cloud Platform (GCP)™, Microsoft Azure™, etc.). An asset 102n may be any service provided by a CSP. Examples of cloud services include virtual machines (VM), container services, serverless compute, block storage, object storage, file storage, relational databases, NoSQL databases, data warehouses, big data processing, load balancers, API gateways, content delivery networks (CDNs), domain name system (DNS) services, network firewalls, identity and access management (IAM), key management services (KMSs), etc.

Some assets may perform multiple functions. For example, an EC2™ cluster may be a cluster of one or more containers (e.g., Docker™ containers) which each run different tasks. One container may run a VM while another container serves a database. The containers may be in communication through one or more ports. The ports may be configured by the CSP provider and/or cloud user. Thus, the relationship between multiple functions within an asset may be determined.

In some embodiments, the cloud user associated assets 102a, 102b, . . . , 102n provide security service 104 access to its cloud computing infrastructure. In some embodiments, upon receiving access to a cloud computing infrastructure, security service 104 utilizes the access to generate ingested metadata 108. For example, security service 104 may access the command line interface (CLI) of a CSP provider and run scripts (e.g., a Bash script) to determine the presence of each asset 102n. After determining the presence of each asset 102n, security service 104 can execute an automated process to generate ingested metadata 108.

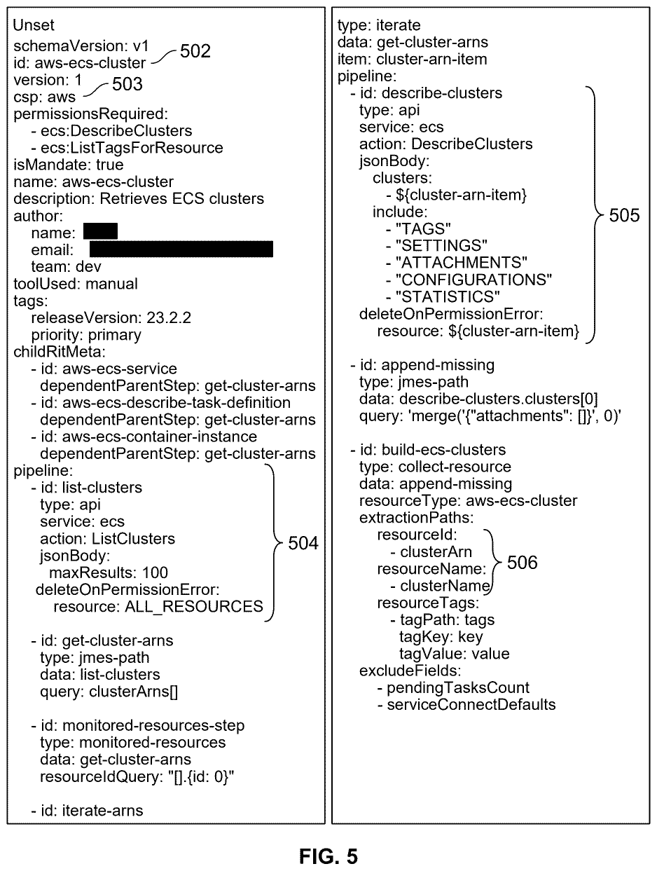

In some embodiments, ingested metadata 108 for a particular asset type may have already been produced by security service 104. An example of an ingested metadata is shown in FIG. 5 as will be further described below.

Ingested metadata 108 comprises information that constitutes assets 102a, 102b, . . . , 102n. Ingested metadata 108 can also include a variety of types of information relating to an . . . , asset 102n, such as information that defines the asset, defines API calls to a CSP environment, defines the definition attribute of an asset, defines the identifier attributes of the asset, tags, pipeline data, fields of data, configuration information, etc.

In some embodiments, each asset 102n has a corresponding item of ingested metadata. The items of ingested metadata for asset 102a, 102b, . . . , 102n together comprise ingested metadata 108. For example, if a cloud computing infrastructure contains assets 102a, 102b, . . . 102n, then ingested metadata 108 may include three items of ingested metadata, one for each asset.

In some embodiments, an item of ingested metadata 108 may be stored as an ingestion template. One or more ingestion templates may represent an item of ingested metadata in a uniform manner. In some embodiments, ingested metadata 108 is a plurality of ingestion templates, where assets 102a, 102b, . . . , 102n each correspond to an ingestion template. An example of an ingested metadata template is provided in FIG. 5 as will be further described below. An ingestion template may be in any format. Examples of ingestion template formats include YAML, JSON, XML, HTML, Markdown, etc.

In some embodiments, an ingested metadata item of ingested metadata 108 may contain API's, which when called, provide information produced by the CSP pertaining to the corresponding asset 102n. In some embodiments, one or more API calls within ingested metadata 108 are used to generate or supplement CSP specification(s) 110. In some embodiments, the CSP provider configures its CSP environment, such that for each asset type (e.g., each AWS™ service) there exists a set of API calls, which can be used to retrieve all definitional information associated with the asset. In some embodiments, all of the definitional information associated with the asset is defined by a set of attributes. An attribute may be an API call, command, variable, etc.

As an illustration, the AWS™ environment is configured such that two API calls, DescribeClusters and ListClusters, may be used to return all definitional information for an EC2™ asset. Ingested metadata 108 corresponding to a set of assets where there are one or more EC2™ assets may contain both API calls. Security service 104 may use both API calls to return all attributes relating to an EC2™ asset, thus fully defining the asset.

In some embodiments, security service 104 retrieves all natural language descriptions for each piece of definitional information. For example, a CSP environment may provide a natural language description for each attribute that is associated with an asset type in their CSP specification(s). Once security service 104 knows all attributes affiliated with an asset type, it can retrieve the natural language descriptions for each attribute by querying the CSP environment. In some embodiments, when security service 104 uses one or more API calls, it receives all attributes associated with the asset and all natural language descriptions for each attribute.

In some embodiments, the process of collecting all the attributes and their natural language descriptions for an asset is iterative. For example, DescribeClusters and ListClusters may return a second set of APIs, where each API corresponds to an attribute. Then, the API corresponding to each attribute is used to return the natural language description of each attribute. In some embodiments, an API call is used by calling the API with a parameter that specifies it should return natural language descriptions as well as the attribute.

In some embodiments, ingested metadata 108 contains the set of API calls for each asset 102n that provides all definitional information associated with asset 102n. Upon calling the API calls contained in ingested metadata 108, security service 104 may receive all definitional information pertaining to every asset 102a, 102b, . . . , 102n (e.g., the entirety of the cloud user's cloud computing infrastructure). In some embodiments, once a security service 104 determines each attribute associated with an asset 102n, it can retrieve all natural language descriptions. All of the retrieved natural language descriptions may be used for creating or supplementing CSP specification(s) 110.

In some embodiments, each individual asset 102n has a corresponding ingestion template. For example, if assets 102a, 102b, . . . 102n constitute two VMs and one storage instance, there may be two VM ingestion templates and one storage instance ingestion template. The ingestion templates for the two VMs may share information such as API calls but differ in information such as the authors of the instance.

Ingested metadata 108 may also contain the defining attribute of asset 102n. The defining attribute of the asset 102n indicates the type of the asset. In some embodiments, the defining attribute facilitates the association of definitional information (e.g., attributes and attribute descriptions) to asset 102n. The relationship between the assets 102a and 102b may be determined by the relationships between the defining attributes. For example, if it is determined that a defining attribute of s3-bucket is associated with a defining attribute of aws-EC2-cluster, then the relationship between an S3 Bucket™ asset and an EC2™ asset is established automatically using the trained/fine-tuned ML model based on vector embeddings.

Ingested metadata 108 may also contain identifier attributes of asset 102n. In some embodiments, a CSP does not consistently use the defining attribute to reference a type of asset 102n. For example, the AWS™ specifications often reference asset types using the Amazon Resource Name™ (ARN). For example, the EC2™ ARN™ is clusterARN. In some embodiments, assets 102a, 102b, and 102n are defined with the defining attribute and one or more identifier attributes. Security service 104 may query the CSP environment to receive a description of the identifier attribute. The description of the identifier attribute may be used to further define the attribute. In some embodiments, the description of the identifier attribute comprises the service description. In some embodiments, the service description adds additional context to the identifier attributes.

The defining attribute (e.g., aws-ecs-cluster), identifier attributes, (e.g., clusterARN), and the natural language descriptions of the identifier attributes (e.g., “the name of the EC2 cluster”) are all known to be affiliated with asset 102n.

In some embodiments, the identifier attributes and their natural language descriptions are counted amongst the associated attributes (e.g., within the collated dataset 112).

In some embodiments, an asset is denoted by a defining attribute, identifier attributes, and/or the description of the identifier attributes. These asset denotators may be used in CSP specification(s) 110 interchangeably to refer to a single asset (e.g., an EC2™ asset). In some embodiments, the presence of any of asset 102a's denotators in any information associated with asset 102n (e.g., associated attributes and/or natural language descriptions) may be used to establish a relationship between asset 102a and asset 102n using the trained/fine-tuned ML model based on vector embeddings.

CSP specification(s) 110 comprises some or all of the information associated with the entirety of a CSP environment. In some embodiments, CSP specification(s) 110 includes a compilation of all publicly available information pertaining to the cloud computing infrastructure for a CSP. For example, CSP specification(s) 110 for AWS™ may contain all AWS™ documentation, API definitions, software development kit (SDK) information, etc. In some embodiments, CSP specification(s) 110 is generated from ingested metadata 108, such that CSP specification(s) 110 comprises all necessary definitional information of assets 102a, 102b, and 102n. In some embodiments, CSP specification(s) 110 contains information that indicates all attributes, their natural language descriptions, and their association with a definitional attribute.

CSP specification(s) 110 may be periodically updated, such as each time the associated CSP updates their cloud computing environment. Security service 104 can query updated CSP specification(s) to generate updated embeddings, thus allowing security service 104 to continue to provide accurate asset relationship insights 120 despite mercurial CSP specification(s).

In some embodiments, security service 104 periodically ingests asset metadata 108 and retrieves CSP specification(s) 110, such that any changes in the CSP environment or the cloud user's infrastructure are accounted for in the information provided (e.g., asset relationship insights 120 and asset relationships 118).

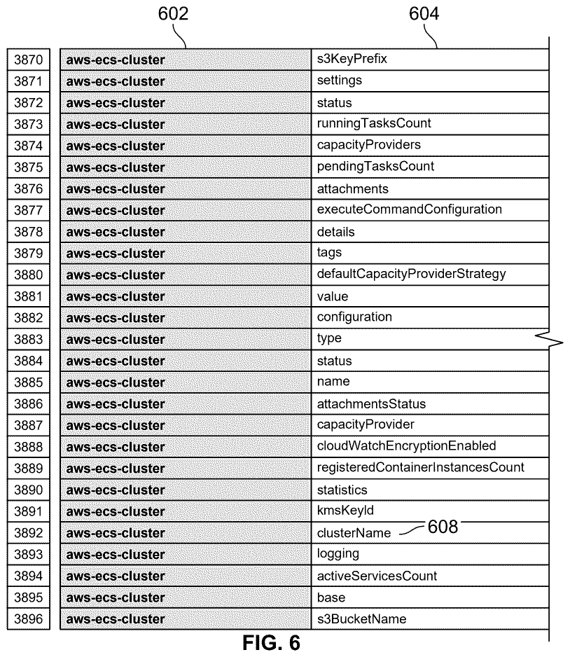

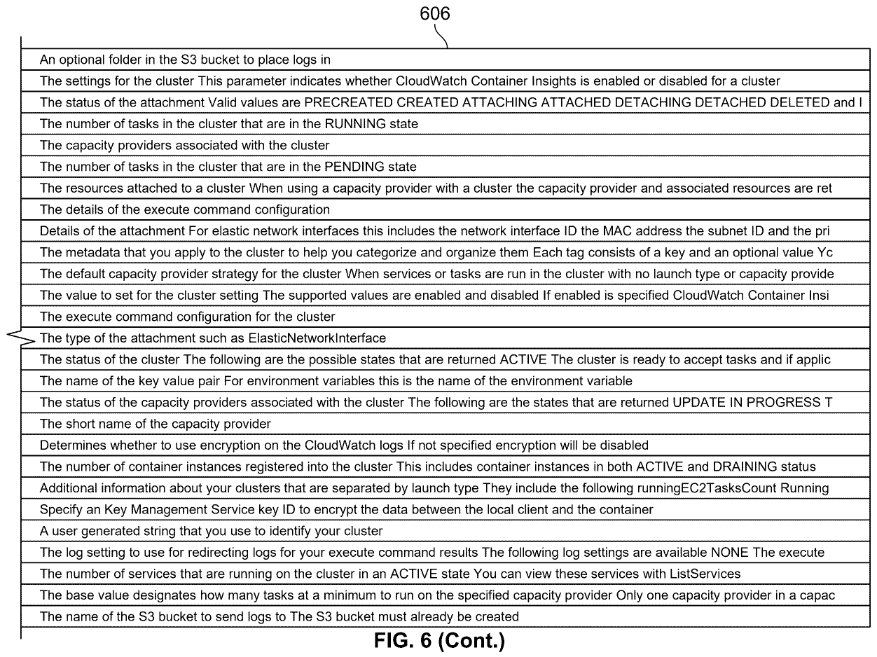

Collated dataset 112 may be created by collating information in ingested metadata 108 with information in CSP specification(s) 110, such that the defining attribute (e.g., aws-ecs-cluster) of each asset 102n is associated with all of its definitional information. Collated dataset 112 may be computationally represented as a three column table of any number of rows, where each row contains a defining attribute, an associated attribute, and the natural language description of the associated attribute. Note that a single asset 102n may have multiple rows. Collated dataset 112 may contain a set of entries (e.g., rows) for all assets 102a, 102b, . . . 102n. An example of a collated dataset is shown in FIG. 6 as will be further described below.

For example, suppose asset 102n is an EC2™ asset. Collated dataset 112 may contain a row for each attribute that is associated with the EC2™ asset, where the first column of a row contains the defining attribute, aws-ecs-cluster, the second column is the associated attribute, e.g., s3BucketName, and the third column is the natural language description of the associated attribute, e.g., “The name of the S3 bucket to send logs to the S3 bucket must already be created.” There may exist a plurality of rows in which the first column contains aws-EC2-cluster (e.g., one row for each associated attribute).

In some embodiments, collated dataset 112 is periodically updated to reflect change in entities' cloud computing infrastructure environment(s) and/or changes in CSP specification(s) 110.

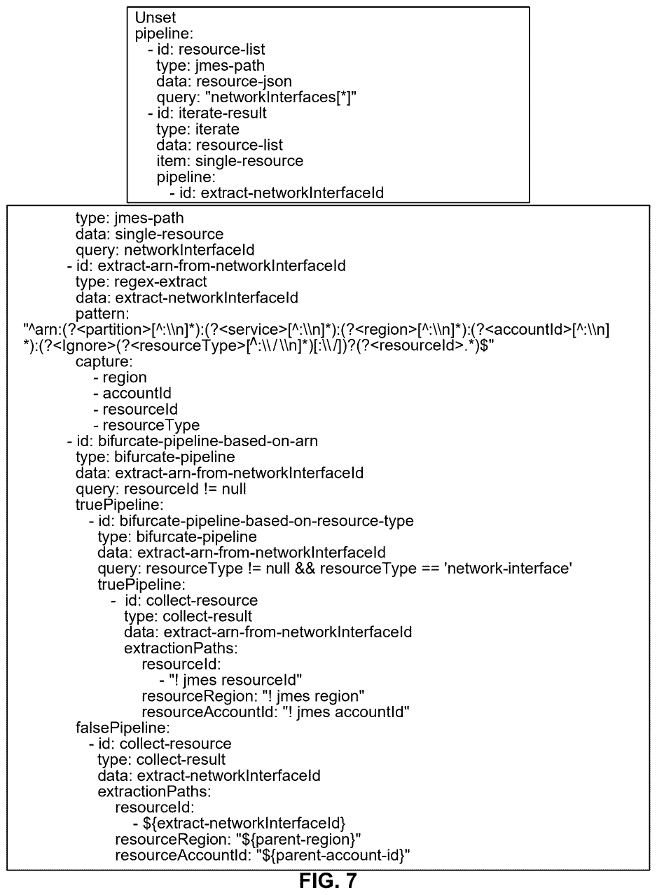

In some embodiments, previously defined asset relationships 114 comprises information that is known regarding asset relationships of a CSP infrastructure. This information may be the result of current solutions that attempt to define relationships between assets 102a, 102b, and 102n. For example, the entity that provides security service 104 may have generated data pertaining to asset relationships of a particular CSP infrastructure in the past. This data may have been generated using human resources. For example, network researchers may have been continuously researching AWS™ documentation in order to provide their customers with useful information pertaining to their cloud computing infrastructure. CSP configurations and specifications change constantly, solutions depending on human resources are costly, require significant time, and can often lead to inaccurate/error prone results. However, some of the data produced from these efforts is known to be current and has been validated. In some embodiments, previously defined asset relationships 114 includes such information indicating asset relationships that have been validated and are known to be current. An example of previously defined asset relationships is shown in FIG. 7 as will be further described below.

In some embodiments, previously defined asset relationships 114 are maintained in a uniform template. A previously defined asset relationship template may be in any format. Examples of previously defined asset relationship template formats include YAML, JSON, XML, HTML, Markdown, etc. In some embodiments, previously defined asset relationships 114 consist of one or more templates, where each template is affiliated with an asset type (e.g., by the defining attribute of an asset) and contains the information pertaining to the relationship of that asset type to another asset type. For example, there may be multiple aws-EC2-cluster asset relationship templates where each template contains information describing its relationship to another asset type (e.g., an EC2™ Network Interface). The template may contain relationships as defined by similar attributes, API calls between the assets, pipelines between the assets, etc. An example of a previously defined asset relationship template is shown in FIG. 6 as will be further described below.

Base embedding model 116 comprises a base text embedding model. Base embedding model 116 may be any propriety or commercially available foundational text embedding model, such as Google's textembedding-gecko™ model. Other examples of base embedding models include BERT, ROBERTa, T5, DistilBERT, Sentence-BERT, DeBERTa, SimCSE, etc.

Base embedding model 116 may be fine-tuned using previously defined asset relationships 114.

In some embodiments, a fine-tuning procedure for the disclosed ML model involves preparing a domain-specific training dataset that encodes the known relationships among various assets.

The fine-tuning procedure may comprise corpus preparation, query preparation, and relationship labelling.

Corpus preparation comprises generating a corpus file. The corpus file may be in one of a variety of formats such as JSON, JavaScript Object Notation Lines (JSONL), YAML, etc. The corpus file may comprise a plurality of entries where each entry corresponds to a distinct asset and includes a unique identifier and a textual description. The textual description may reference defining attributes, identifier attributes, and their natural language descriptions.

Query preparation comprises generating a query file. The query file may be in one of a variety of formats such as JSON, JSONL, YAML, etc. The query file may comprise a plurality of entries where entry is formatted similarly to the corpus. Each query entry represents an asset or asset-related concept for which relevant or related corpus entries are sought.

Relationship labelling comprises a generating a label file. The label file may be in one of a variety of formats such as Tab-Separated Values (TSV), Comma Separated Values, (CSV), JSON, YAML, etc. The label file comprises entries associated with certain queries. Each entry comprises an associated relevance score. A higher score indicates a stronger relationship between the queried asset and the corpus asset, such that the label file encodes the known asset relationships 114. This ensures that the fine-tuning procedure directs the embedding model to position semantically related assets more closely within the embedding space.

For example, the query may comprise of a query for a relationship associated with the natural language “is_associated_with” for two attributes “aws-ec2-describe-instances” and “aws-ec2-describe-security-groups.” The relationship labelling for this query may comprise of a relationship score, such as 2. FIG. 11 provides another example of training data for use in a fine-tuning procedure.

With the training data, base embedding model 116 may be fine-tuned to reflect the relationship labels and their associated queries using any method for fine-tuning a base embedding model. Examples of fine-tuning techniques include the following: Supervised fine-tuning, Contrastive learning, Triplet loss training, Hard negative mining, Domain adaptation, Few-shot learning, Data augmentation, Curriculum learning, Multi-task learning, Knowledge distillation, Self-supervised learning, Prompt engineering, Layer freezing, Hyperparameter tuning, Adversarial training, Transfer learning, etc.

In some embodiments, fine-tuning includes preparation of a corpus; preparation of a plurality of queries; and preparation of a plurality of relationship labels associated with the plurality of relationship of queries. The corpus, plurality of queries, and relationship labels are used to fine-tune a base embedding model (e.g., base embedding model 116).

In some embodiments, the fine-tuned embedding model is used to create embeddings for all asset denotators (e.g., defining attributes, identifier attributes, and the description of the identifier attributes). The association between these asset denotators and their corresponding asset type (e.g., EC2™) is maintained. In some embodiments, the fine-tuned embedding model is used to create embeddings (e.g., vector embeddings) of all data within collated dataset 112.

In some embodiments, the associated attributes (e.g., column 2) and the natural language description of each of the associated attributes (e.g., column 3) are embedded within an embedding space. The embedding is performed such that the relationship between the defining attribute (e.g., column 1), the associated attribute (e.g., column 2), and the natural language description (e.g., column 3) is contained within the embedding space (e.g., an n-dimensional vector embeddings space).

This process results in an embedding space that defines all relationships between assets 102a, 102b, . . . , 102n. The embedding space may define asset relationships 118.

The embedding space may now be queried with asset 102n to determine its relationships and information describing its relationships based on a threshold distance comparison in the embedding space (e.g., a similarity metric, probability score, score correlation metrics, etc.). In some embodiments, security service 104 receives asset 102a, determines the embeddings of asset 102a's denotators, and determines how each of asset 102a's denotators are defined within the embedding space such that the set of relationships between asset 102a and assets 102b, . . . 102n is determined.

For example, suppose asset 102a is an EC2™ instance. The defining attribute is aws-ecs-cluster. The identifier attributes are clusterARN and clusterName. The natural language description for clusterARN is “The Amazon Resource Name (ARN) that identifies the cluster . . . ” The natural language description for the clusterName is “A user-generated string that you use to identify your cluster.” Each of these pieces of information may be embedded within the embedding space, such that its position in the embedding space may be used to define the relationship of the EC2™ to other asset types (e.g., based on a threshold distance comparison). For example, if an attribute associated with an S3 Bucket™ asset (or its English language description) contains “cluster,” then the embedding space is generated such that the embeddings of clusterARN, clusterName, and their descriptions are generally within a threshold distance to the embeddings of the attribute associated with S3 Bucket™.

In some embodiments, asset relationships 118 are determined by the embeddings (e.g., vector embeddings) generated for asset 102a, 102b, . . . 102n. For example, the embedding space is automatically generated by applying base embedding model 116 to collated dataset 112. As such, asset relationships 118 can be determined using the fine-tuned embedding model to collated dataset 112.

In some embodiments, asset relationships 118 includes data that indicates the relationships and similarities between each of the assets 102a, 102b, . . . , 102n. Asset relationships 118 may present the asset relationships in a visually useful manner such as a graph and/or various other formats. The cloud user associated with assets 102a, 102b, . . . , 102n, may use the visual representation of its asset relationships to better understand its cloud computing infrastructure.

In some embodiments, security service 104 exposes nth distance relationships between assets. For example, if there exists a relationship between a first asset and a second asset, then there exists a relationship between the first asset and all other assets related to the second asset, and the assets related to those assets, etc. Asset relationships 118 may contain the relationship that a first asset 102a has to a third asset 102n through a second asset 102b.

To illustrate further, if data from a relational database asset is automatically stored in a storage database asset by a data integration asset, asset relationships 118 can indicate that the relationship between the storage database asset and the relational database asset exists.

In some embodiments, security service 104 produces asset relationship insights 120. Asset relationship insights 120 are determined by utilizing asset relationships 118 to determine actions that will result in a cloud computing infrastructure that is safer from attacks, cheaper to operate, more efficient, etc. For example, suppose security service 104 becomes aware of a new exploit that can be used to attack asset 102a, then by applying the above-described techniques, the security service can determine that a given cloud user's cloud computing infrastructure is prone to the new exploit and can notify the cloud user of this exploit and provide configuration changes/settings to secure the cloud user's cloud computing infrastructure (e.g., as the security service 104 can utilize the disclosed embedding model to effectively and efficiently determine how such an exploit of asset 102a can be used to attack assets 102b, . . . , 102n).

In some embodiments, asset relationships 118 are determined by generating a similarity score (e.g., using a threshold distance score for the vector embeddings) for each associated attribute against each defining attribute. The asset relationship between the defining attribute comprises the similarity scores of each associated attribute to the two defining attributes. As an illustration, suppose there is a shared attribute, Get_Logging_Data_API. The embeddings may be used to define the similarity of Get_Logging_Data_API to asset 102a and the similarity score of Get_Logging_Data_API to asset 102b. Using the two similarity scores, the similarity score between asset 102a and asset 102b may be determined.

In some embodiments, asset relationships 118 includes the associated attributes to facilitate an asset relationship. For example, suppose Attribute 1 connects asset 102a to asset 102b through a second Attribute 2 (e.g., both API's make similar calls). Security service 104 may use the embeddings to demonstrate that the relation between asset 102a and asset 102b is facilitated by Attribute 1 and Attribute 2.

In some embodiments, the metric associated with the relationship (e.g., a similarity score) between assets may be organized using a threshold value (e.g., a threshold distance value). For example, asset relationships with metrics that are higher than a threshold value are highly correlated and represent the most likely threat for an attack vector.

Asset relationships 118 may be determined in any number of ways. The relationship can be a conglomeration of shared relationships of one or more associated attributes, shared relationships of defining attributes to associated attributes, relationships of asset denotators to other associated attributes, defining attributes within associated attributes, etc. It should be apparent to one skilled in the art that the nature of an embedding space allows for a wide variety of techniques to determine the relationship between assets 102a, 102b, . . . , 102n.

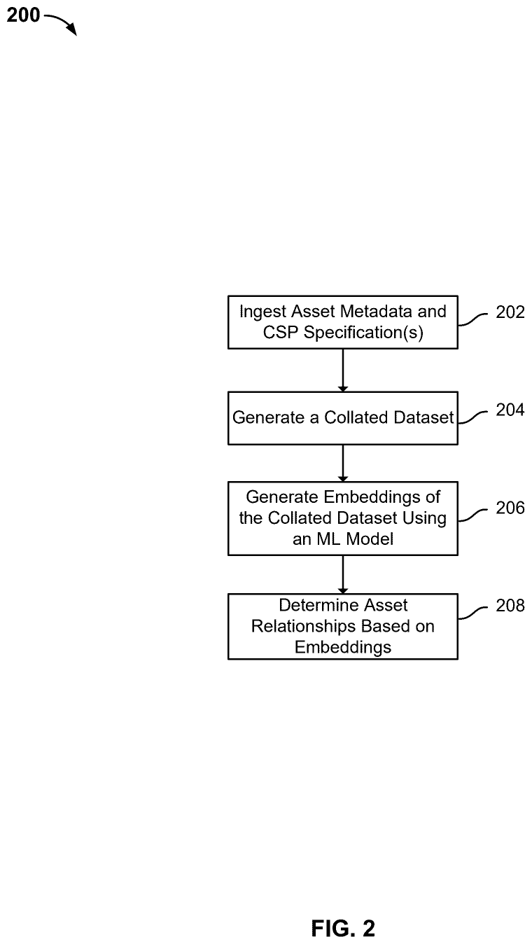

FIG. 2 is a process diagram illustrating a process for determining relationships between a cloud computing infrastructure's assets using an embedding model in accordance with some embodiments. In some embodiments, process 200 is executed by a security service (e.g., a cloud security service (CSS), such as similarly described above with respect to FIG. 1) using a system and components as similarly described above with respect to FIG. 1.

At 202, asset metadata and CSP specification(s) are ingested. The asset metadata pertains to an entity's cloud computing infrastructure and the CSP specification(s) pertain to the CSP that is hosting the cloud computing infrastructure. In some embodiments, an entity provides a list of assets that are described by the ingested asset metadata. The ingested metadata may be data formatted in a particular manner such that an automated process can extract information in a uniform manner (e.g., a YAML parser, JSON parser, etc.). Examples of ingested metadata formats include YAML, JSON, XML, HTML, Markdown, etc. Each asset may correspond to an ingested metadata item. The ingested metadata may contain a variety of types of information relating to an asset 102n such as information that defines the asset, defines API calls to a CSP environment, defines the definition attribute of an asset, defines the identifier attributes of the asset, tags, pipeline data, fields of data, etc. An example of an ingested metadata is shown in FIG. 5 as will be further described below.

In some embodiments, the CSP specification(s) are ingested by querying a CSP for documentation, API definitions, software development kit (SDK) information, etc. In some embodiments, the CSP specification(s) are generated by querying a CSP for information that is defined within the ingested asset metadata. In some embodiments, the queried information arrives in a uniform manner that can be parsed to determine the natural language description of an attribute. For example, upon making an API call associated with an EC2™ asset, the following information may be received:

```
  “s3BucketName”: {
      “shape”:“String”,
      “documentation”:“<p>The name of the S3 bucket to send logs
to.</p> <note> <p>The S3 bucket must already be created.</p> </note>”
    },
```

In this example, the “s3BucketName” is an associated attribute and “documentation” is associated with the natural language description “The name of the S3 bucket to send logs to. The S3 bucket must already be created.” In this format, the device ingesting the CSP specification(s) can rapidly determine the associated asset and the natural language description through a parsing process.

In some embodiments, an API call may be used to receive a plurality of entries, such as the entry in the example above, such that every associated attribute and its natural language description for an asset are received. In some embodiments, two or more API calls are iteratively used to receive all attributes and their associated natural language descriptions for a given asset.

At 204, a collated dataset is generated. The collated dataset may contain information collated from ingested asset metadata and CSP specification(s). In some embodiments, each asset within an entity's infrastructure is defined by an ingested asset metadata item. In some embodiments, each ingested metadata item contains a defining attribute that defines the asset type. The defining attribute is associated with a set of associated attributes and a natural language description for each associated attribute. Thus, each asset type within the cloud user's infrastructure is collated with each of its associated attributes and their natural language descriptions. In some embodiments, asset denotators are included as part of the collated dataset. An example of a collated dataset is shown in FIG. 5 as will be further described below.

At 206, embeddings of the collated dataset are generated using a machine learning (ML) model. The machine learning model may be any machine learning model that is able to vectorize natural language such that an embedding space is created. In some embodiments, the machine learning model comprises a base text embedding model that has been fine-tuned with previously defined asset relationships. The previously defined asset relationships may be information indicative of any relationships that are known to exist between one or more assets in a given CSP environment.

In some embodiments, embeddings are created for each of the denotators of an asset type. The denotators of an asset type include the defining attributes, the identifier attributes, and the descriptions of the identifier attributes. In some embodiments, the embeddings of the denotators are created within the same embedding space of all of the data within the collated dataset. The embedding space is configured such that the asset type that an embedding is associated with is known. Thus, the relationship of an embedding to another embedding is indicative of a relationship between the embeddings' associated asset types (e.g., an EC2™ to a S3 Bucket™).

At 208, asset relationships are determined based on the embeddings. The embeddings generated at step 206 define an embedding space that comprises embeddings for asset denotators, associated attributes, natural language descriptions, and any other information that defines one or more attributes. Thus, the relationships between the assets is defined in the embedding space as similarly described above with respect to FIG. 1.

In some embodiments, in order to determine an asset's relationship to other assets, a similarity metric/score (e.g., a distance comparison) is determined based on the embeddings of each of the asset's denotators. The relationships of each of the asset's denotators to all other assets is similarly determined. Each of the relationships of the denotators to all other assets may be combined in any manner to determine the asset's relations to each of the other assets.

Process 200 may be used to determine the nth degree relationships, where the assets are related through n intermediate assets.

In some embodiments, step 208 produces a set of asset relationships for each asset that is defined in the embedding space. For example, an EC2™ asset may have a relationship to S3 Bucket™, Glue™, RDS™, Lambda™, etc. The relationship between EC2™ to another asset may be determined by a combination of the relationships between the embeddings of each EC2™ denotator to the asset.

In some embodiments, the relationship between a first asset and a second asset is enhanced with a similarity score. The similarity score provides a probability of the match. In some embodiments, a threshold similarity score is used to determine whether there is a strong correlation between the assets or a weak correlation between the assets. In some embodiments, a similarity score between a first asset and a second asset is calculated based on the context of the first asset's similarity to all other assets.

For example, the average distance of denotator of the EC2™ asset to all denotators of other assets (e.g., S3 Bucket™, Glue™, RDS™, Lambda™, etc.) within the embedding space may be determined. The closest average distance between two assets in the embedding space is the distance between EC2™->Glue™. The EC2™->Glue™ may be represented with a similarity score which is calculated from the difference between denotators of EC2™ and Glue™ and each the similarity score of each relationship EC2™->S3 Bucket™, EC2™->RDS™, EC2™->Lambda™ may be represented as a percentage of difference of their denotators. Now, upon determining that there is a new possible attack on an entities' EC2™ asset, an entity can know which assets are most vulnerable by the similarity score.

This is merely one example of how the embedding space may be used to generate insights on a cloud computing infrastructure. As is evident to one skilled in the art, there exists a myriad of methods to determine the relationships of an asset to another asset using an embedding space generated at 206. This is because relationships between embeddings and how those relationships compare to other relationships are inherent to embedding spaces. The various disclosed techniques can produce relationships that can then be used to produce a variety of insights into a cloud computing infrastructure.

In some embodiments, the asset relationships may be facilitated by the associated attributes that are shared between the assets. One example is if Attribute 1 connects Asset 1 to Asset 2 through a second Attribute 2 (e.g., both API's make similar calls). Process 200 is able to not only demonstrate the relationship between Asset 1 and Asset 2 but also demonstrate that the relation is through Attribute 1 and Attribute 2.

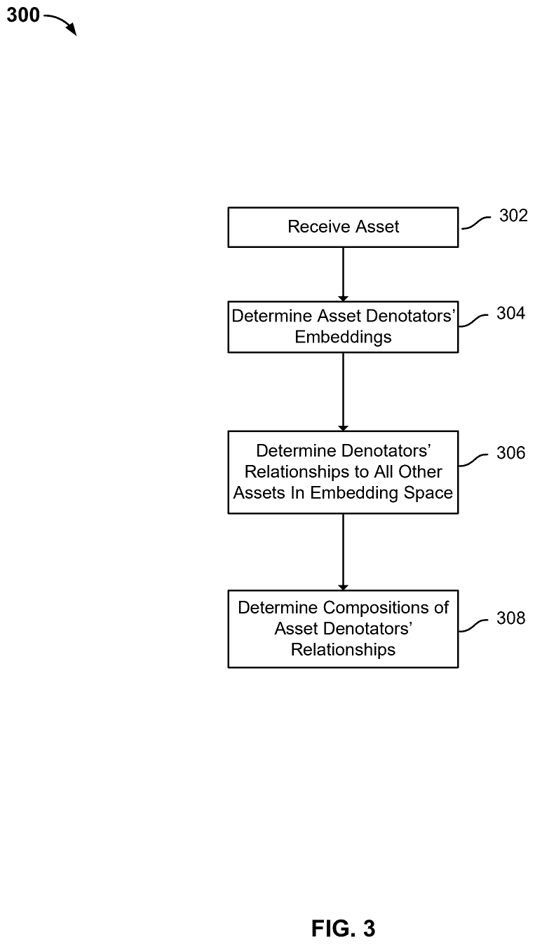

FIG. 3 is a process diagram illustrating a process for determining the relationships for an asset in accordance with some embodiments. In some embodiments, process 300 is implemented to perform part or all of step 208. In some embodiments, process 300 is executed one or more times for a set of assets using the above-described embedding model. In some embodiments, process 300 is executed by a security service (e.g., a cloud security service (CSS), such as similarly described above with respect to FIG. 1) using a system and components as similarly described above with respect to FIG. 1.

At 302, an asset is received. The asset may be received from a list of assets as defined by one or more ingested metadata items. The asset may also be received from an entity querying an asset on the device executing process 300 to determine its relationships. In some embodiments, when the asset is received from a list of assets, process 300 is repeated until the relationships of each asset within the list of assets are known. In some embodiments, the asset is received through receiving the asset's defining attribute (e.g., aws-ecs-cluster).

At 304, the asset denotator's embeddings are determined. The asset denotator's embeddings may be determined because the association between the asset's defining attribute and its denotators are maintained by a device executing process 300 and/or a device executing process 200, such as a security service.

At 306, each asset denotator's relationship to all other assets in the embedding space is determined. In some embodiments, one or more relationships (e.g., in which each relationship is the asset denotator's relationship to a second asset) are produced for the asset. This can be automatically performed by querying the embedding space with each denotator. Because each denotator is embedded in the embedding space, the relationship of the denotator to all other assets can be effectively and efficiently determined as similarly described above with respect to FIG. 1. For example, the relationship of the asset ResourceID identifier attribute to an attribute associated with another asset may be determined from the relationship of the ResourceID identifier attribute's embedding to the associated attribute's embedding.

In some embodiments, the relationship between the asset denotator to another asset is facilitated by an associated attribute. As an illustration, suppose the natural language description of an attribute associated with a storage asset mentions a denotator of a data integration asset. In this case, the embedding space will reflect a relationship between the storage asset and the data integration asset.

At 308, compositions of asset denotators' relationships are determined. In some embodiments, each composition corresponds to the asset's relationship to a n-th asset. The composition is created by combining the asset denotator's relationship to the second asset. The combination may be produced using any conceivable method of composing/combining/amalgamating/representing metrics that measure relationships. For example, the asset's relationship to an n-th asset may be determined by calculating an averaging of the relationship of each of the asset's denotators to the n-th asset. To illustrate, suppose three of the asset's denotators have a relationship that is defined by the measurements 4, 2, and 6 to the n-th asset. The asset's relationship to the n-th may be the average of these measurements, 4. In some embodiments, the composition of the asset denotator's relationship to a second asset may be used to generate a similarity score which is calculated based at least in part on the relationships of all other assets to each other. For example, if the closest asset relationship is 1, then an asset relationship of 2 may have a similarity score of 50%.

As an illustration, an EC2™ instance has the denotators clusterName and “A user-generated string that you use to identify your cluster” along with other denotators. The embeddings of clusterName and “A user-generated string that you use to identify your cluster” are known to be associated with the EC2™ asset. Therefore, their relationships to other assets within the embedding space can be composed together to generate the EC2™ relationship to the other embeddings.

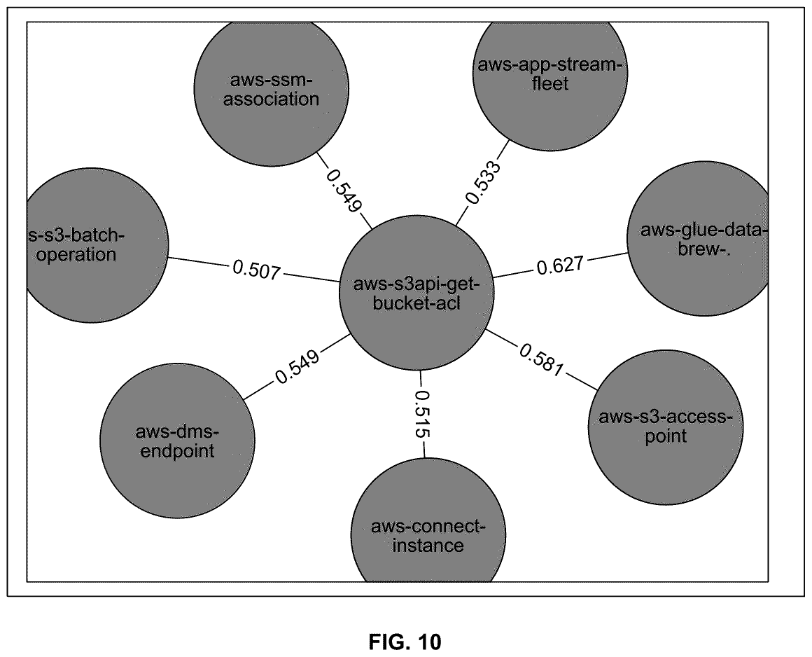

In some embodiments, the asset relationships comprise all of the relationships that the asset has with all other assets. In some embodiments, the asset relationships are used for various other applications. For example, the asset relationships that are determined in process 200 comprise asset relationships generated by process 300. In some embodiments, the asset relationships can be used to produce visualizations of an entity's cloud computing infrastructure. An example of a visualization is shown in FIG. 10 as further described below.

In the example shown, process 300 returns all the relationships of one asset. Process 300 may be executed one or more times to determine the relationships for one or more assets.

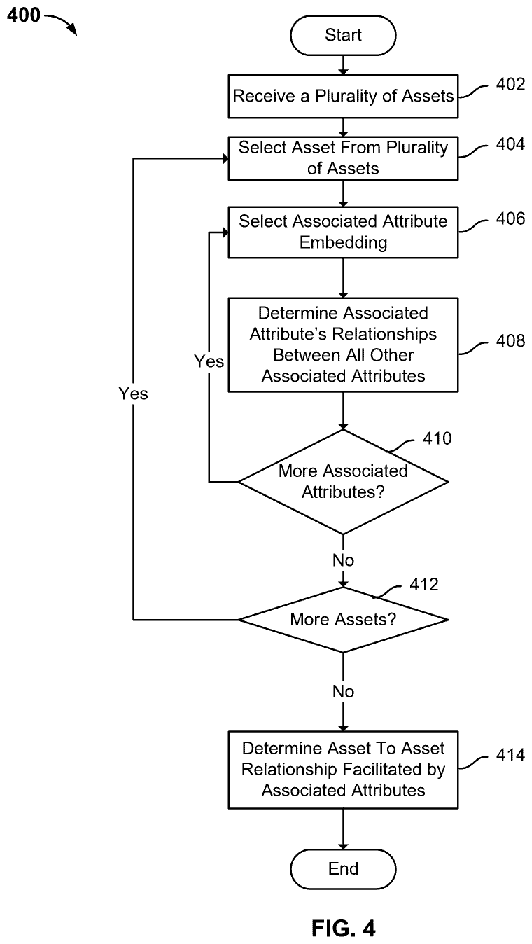

FIG. 4 is a process diagram illustrating a process for determining the relationship between a set of assets in accordance with some embodiments. In some embodiments, process 400 is implemented to perform part or all of step 208. In some embodiments, process 400 is executed on a security service. Process 400 may return the similarity between all assets as facilitated by the plurality of associated attributes. In some embodiments, associated attributes are comprised of asset denotators as well as other attributes. Process 400 can be implemented using the embedding model (e.g., that includes vector embeddings for a set of assets) as similarly described above with respect to FIG. 1.

At 402, a plurality of assets is received. In some embodiments, the plurality of assets that comprises a cloud infrastructure is received. In some embodiments, the assets are received by ingesting metadata associated with a cloud infrastructure. The plurality of assets may be received in the form of a list of assets.

At 404, an asset is selected from the plurality of assets. A cloud computing infrastructure may be comprised of the plurality of assets. The plurality of assets may be represented by a plurality of ingested metadata items. The plurality of assets may be represented by a plurality of asset types (e.g., EC2™, S3 Storage™, Glue™, etc.).

At 406, an asset's associated attribute embedding is selected. The asset's associated attribute may be selected from a collated dataset which contains all the attributes associated with the asset. The embedding is determined because the associated attribute's association with its embedding is maintained in the embedding space. The associated attributes may include asset denotators.

At 408, the associated attribute's relationships between all other associated attributes are determined. The embedding space maintains the relationship between the associated attribute and all other associated attributes. All other associated attributes may include the attributes that are associated with the same asset that the associated attribute is associated with. The embeddings of the associated attributes may comprise the natural language description of the associated attributes. The relationship may be any metric that reflects the relationship between the two associated attributes in the embedding space (e.g., a similarity metric, probability score, score correlation metrics, etc.).

For example, suppose the list of assets received at 402 contains Asset A and Asset B. Asset A has Attribute A1, Attribute A2, Attribute A3, . . . . Attribute An and Asset B has Attribute B1, Attribute B2, Attribute B3, . . . . Attribute Bn. At 404, suppose Asset A is selected. At 406, Attribute A1 is selected. At 408, the relationship between Attribute A1 and Attribute A2, Attribute A3, . . . . Attribute An, and Attribute B1, Attribute B2, Attribute B3, . . . . Attribute Bn is determined.

At 410, whether there are more associated attributes is determined. Upon the determination that there are more associated attributes, process 400 proceeds to 406. Upon the determination that there are no more associated attributes, process 400 proceeds to 412.

At 412, whether there are more assets in the list of assets is determined. Upon the determination that there are more assets, process 400 proceeds to 404. Upon the determination that there are no more assets, process 400 proceeds to 414.

At 414, the asset to asset relationship as facilitated by associated attributes is determined based at least in part on the embeddings and a similarity score. This similarity may be comprised of any conceivable way to combine the relationships between one or more associated attributes. Referring back to Asset A and Asset B, the relationship between the two may be a composition of all the relationships between each of their associated attributes. For example, if the relationship between two associated attributes is the distance between the two in the embedding space, the relationship between the two associated attributes may be the average of all distances (e.g., the average of Attribute A1->Attribute B1, Attribute A1->Attribute B2, Attribute A1->Attribute B3, . . . . Attribute A2->Attribute B1, Attribute A2->Attribute B2, Attribute A2->Attribute B3, . . . . Attribute An->Attribute Bn). There exists a myriad of methods to compile the relationships between associated attributes to return an overall relationship between two assets.

Process 400 not only determines that assets are related, but it also determines how the assets are related. Therefore, process 400 may also be used to automatically generate graphical representations of the asset relationships, such as the example in FIG. 10, which depicts the relationship between the assets as facilitated by their associated attributes as will be further described below.

Processes 300 and 400 are both illustrative examples of how the disclosed embedding model can be used to determine/define relationships between assets in a cloud computing infrastructure. In this example implementation, the embedding space comprises embedded asset denotators, embedded associated attributes, and embedded natural language descriptions of all attributes. Further, the relationships of these embeddings to the definitional attribute is known. Thus, the embedding space facilitates the derivation of asset to asset relationships as similarly described above and further described below.

FIG. 5 is an example of an ingested metadata in accordance with some embodiments. In the example shown, the format of the ingested metadata is YAML, however, ingested metadata can be in any appropriate format such as YAML, JSON, XML, HTML, Markdown, etc. The example shown is an ingestion metadata item for an EC2™ asset. The template may be the key pairs and the template is filled out by the value pairs.

Upon parsing the example shown, the defining attribute 502 may be easily determined. Defining attribute 502 has a key of “id” and a value of “aws-ecs cluster.” CSP name 503 denotes the CSP of the asset. In this example, it is AWS™. This information can be used to determine where to query API calls and receive defining information.

Defining API call 504 denotes an API call which may be used to define the asset. In this example, defining API call 504 is the API call for ListClusters. In some embodiments, the set of API calls that define the attribute are present in the ingestion template. Defining API call 505 is the API call for DescribeClusters. In this example, defining API calls 504 comprises the set of API calls which can be used to define the attribute. In some embodiments, the API calls within the ingestion metadata are used to retrieve all the defining information (e.g., attributes and natural language descriptions) in the CSP specification(s). In some embodiments, the CSP specification(s) for all the defining information are retrieved iteratively, where the first step of the iterative process is to call the API calls within the ingestion template.

Identifier attributes 506 is used to denote the asset with which ingestion metadata is associated. In this example, the clusterARN and the clusterName attributes denote the EC2™ asset and may be used within CSP documentation to refer to an EC2™ asset.

In some embodiments, defining attribute 502, defining API calls 504 and 505, and identifier attributes 506 are stored in a uniform manner across all ingestion metadata for all assets. Therefore, a uniform process can extract this information for each asset. This uniformity greatly reduces the difficulty of defining a plurality of assets.

FIG. 6 is an example of a collated dataset in accordance with some embodiments. In the example shown, column 602 contains the defining attributes, column 604 contains the attributes associated with the defining attribute (e.g., API calls, commands, variables, etc.), and column 606 contains descriptions of the defining attribute as provided by the CSP specification(s). This example shows one or more entries of a collated data set for a cloud computing infrastructure that contains an EC2™ asset.

Column 602 contains the defining attribute. The defining attribute may be unique to each type of asset within a CSP. In some embodiments, a set of API calls, which may be attributes themselves, can be used to retrieve n associated attributes and their descriptions, which fill n rows in column 604 and n rows in column 606, respectively. Data in column 602 may be embedded in the embedding space.

Column 604 contains associated attributes of a defining attribute. As shown in this example, a defining attribute in column 602 can have a plurality of associated attributes. In some embodiments, column 604 contains an asset denotator such as an identifier attribute.

Column 606 contains the description of the associated attribute as provided by the CSP specification(s).

In some embodiments, the embedding model embeds column 604 and column 606 and maintains the embeddings' association with the defining attribute in column 602. In some embodiments, data in column 602 is embedded as well. The embedding space further contains embeddings of asset denotators (e.g., defining attributes, identifier attributes, and the description of the identifier attributes). In this example, entry 608 for clusterName is an asset denotator and is contained in the collated dataset. The embedding for the identifier attribute (clusterName) and its natural language description (“A user generated string that you use to identify your cluster”) for entry 608 is used to identify the relations of the asset in the embedding space. In other words, if information in entry 608 is embedded in information associated with a second asset, this may indicate a stronger relationship between the aws-ecs-cluster and the second asset than would be indicated by other entries. In some embodiments, querying an EC2™ asset on an embedding space comprises querying the embedding of information similar to that found in entry 608 (e.g., asset denotators).

FIG. 7 is an example of asset relationship metadata in accordance with some embodiments. In some embodiments, the entity providing a service to determine relationships between assets in the cloud computing infrastructure has prior data that indicates relationships between assets. This data may be used to train/fine-tune a base embedding model that is used to create the embedding space, such as similarly described above with respect to FIG. 1.

In the example shown, a previously defined asset relationship of an EC2™ asset and an EC2™ Network Interface asset is shown. In the example shown, the format of the previously defined asset relationship is YAML, however, ingested metadata can be in any appropriate format such as YAML, JSON, XML, HTML, Markdown, etc.

In some embodiments, these templates are parsed to create the training dataset needed to fine-tune the embedding model. In some embodiments, a corpus file is created that contains two columns, the first column containing the ID of the corpus, (e.g., the asset type), the second column containing the text associated with the asset type, which will either be an attribute or a natural language description of the attribute. A second query file is prepared which contains the two rows, the ID of the query, and the text of the query, which may be the asset that is being queried. Now, using the already established relationships, a third file with training labels may be prepared. The third file contains a similarity score between a query and a corpus. These three files may fine-tune the embedding model such that it may more accurately determine the relationships between assets.

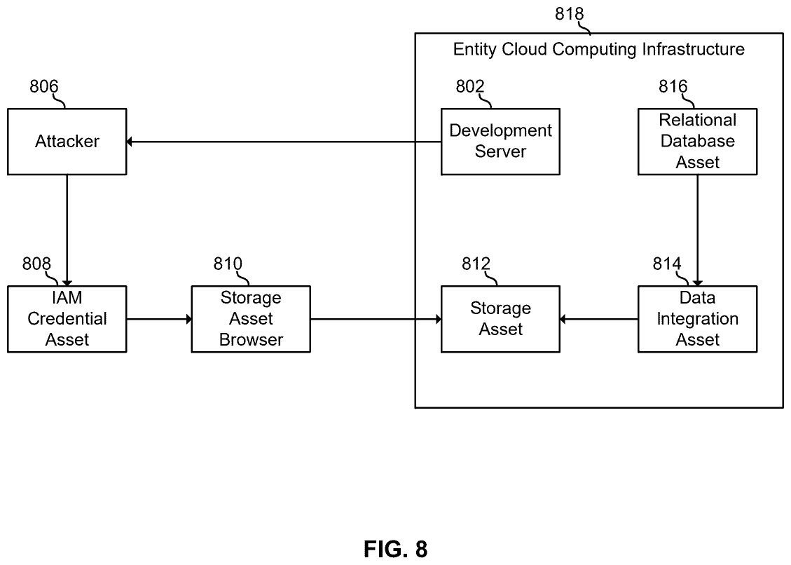

FIG. 8 is an example of an attack on a cloud computing infrastructure. This exploit is known as the “CloudDon” exploit and was used on a Korean e-commerce company. This exploit is an example of an exploit that the techniques disclosed herein can prevent. In this exploit, sensitive customer information in the e-commerce entity's cloud computing infrastructure 818 on the relational database asset 816 was accessed through other cloud assets. The attacker accessed this customer information and sold it on the web.

The company was using development server 802 to develop its website but the employees mistakenly left the development server 802 open to the public. Attacker 806 determined authentication information by accessing development server 802. Attacker 806 used this variable to access IAM credential asset 808. Attacker 806 determined the Uniform Resource Locator (URL) for storage asset 812 (e.g., S3 Bucket™). Attacker 806 was able to access storage asset 812 by using storage asset browser 810 (e.g., S3 Browser™).

In the e-commerce's cloud environment, there was a link between relational database asset 816 (AWS RDS™) and data integration asset 814 (AWS Glue™). The data integration asset 814 was configured by the CSP provider to store sensitive customer information contained within relational database asset 816 in storage asset 812. This unknown asset relationship is what caused the exploit to be successful. The cloud user was not aware of the relationship between relational database asset 816, data integration asset 814 and storage asset 812. Therefore, it would not have expected that the sensitive data on relational database asset 816 could be reached if the attacker gained access to storage asset 812.

Because it was not known that relational database asset 816 was sending information to storage asset 812, the authentication required for storage asset 812 was not the same as that required for relational database asset 816. Therefore, attacker 806 was able to access data on relational database asset 816 without the authentication that is normally required to access relational database asset 816. If the relationship between assets was known, the e-commerce company would have been able to prevent this exploit by ensuring that storage asset 812 had the same authentication as relational database asset 816.

The techniques disclosed herein would have quickly detected this misconfiguration and prevented the exfiltration of the sensitive data maintained on relational database asset 816 through storage asset 812.

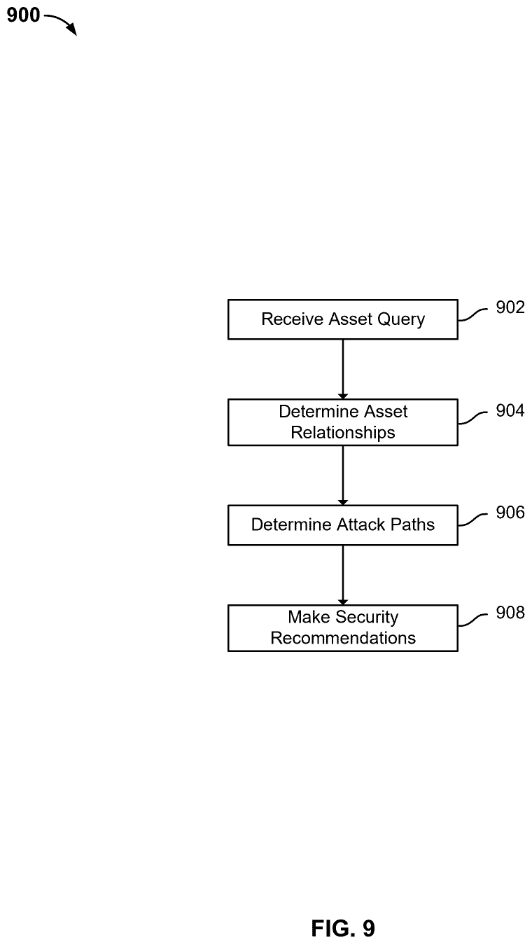

Using the techniques disclosed herein, the misconfiguration would have been detected. First, the ingestion data of the three assets would have led to the CSP specification(s) (e.g., through definitional API calls, such as DescribeClusters) pertaining to all of the definitional information of the three assets (e.g., attributes and natural language descriptions). A collated dataset containing all the attributes with the associations to their asset type (e.g., relational database asset, data integration asset, and storge asset) would have been created. The collated dataset would have been embedded into an embedding space that contained the previously hidden/unnoticed relationship between relational database asset 816 and storage asset 812 (e.g., as it would have known the relationships between data integration asset 814 to each of the other assets using the above-described embedding model). An example process that the e-commerce company could have executed to receive security recommendations to protect the sensitive data on relational database asset 816 is shown in FIG. 9.

FIG. 9 is a process diagram illustrating a process for making security recommendations regarding cloud computing infrastructure in accordance with some embodiments. Process 900 assumes that the cloud user has already used a security service (e.g., security service 104) to determine asset relationships in their cloud computing infrastructure (e.g., by executing process 200). In some embodiments, process 900 is executed by a security service using a system and components including the embedding model (e.g., that includes vector embeddings for a set of assets) as similarly described above with respect to FIG. 1.

At 902, an asset query is received. In some embodiments, the asset query corresponds to an asset that the cloud user has a particular interest in protecting from an exploit. One example is an asset which comprises a database with sensitive customer information.

At 904, the asset relationships are determined. The asset is queried on an asset embedding space which represents the cloud user's cloud computing infrastructure. All asset denotations of the asset are queried on the asset embeddings. Compositions of the relationships between all asset denotations are determined. Using the compositions, the relationships of the assets are determined. Step 904 may be implemented in part or in whole by process 300.

At 906, attack paths are determined. The attack paths indicate the ways in which an attacker may access the asset that was queried. In some embodiments, an attack path is comprised of an asset that is related to the queried asset. In some embodiments, assets that are determined to be highly related to the asset are attack paths. Assets may be highly related if they share a large number of attributes when compared to the relationships of other assets. Assets may also be highly related if denotations of an asset are repeatedly mentioned in an asset's definitional information as opposed to merely sharing attributes.

Referring back to FIG. 8, if relational database asset 816 is queried at 902, the attack paths at 906 can include all the assets that are related to the asset. This would include both storage asset 812 and data integration asset 814. Thus process 900 could be used to anticipate the attack depicted in FIG. 8.

At 908, a security service can automatically generate security recommendations. In some embodiments, the mere existence of a relationship allows an entity to determine that their cloud computing infrastructure has a misconfiguration. For example, the cloud user may view the asset relationships and figure out that a database with a lower level of authentication is being filled with data from a database with higher authentication. In another example, the cloud user may realize that access to a less secure asset allows API calls to a more secure asset without the necessary level of authentication. The solutions to these attack paths can be applied by the cloud user or suggested by the security service provider.

Solutions to attack paths detected by the techniques disclosed herein may comprise increasing the authentication to an asset to protect a related asset. In another example, the API calls from a less secure asset to a more secure asset may be reconfigured such that it is impossible to make the call or that the call needs proper authentication. Once the relationships between assets are determined, there may be a myriad of potential solutions to prevent an attack.

FIG. 10 is an example of a visual representation of a cloud computing infrastructure in accordance with some embodiments. In some embodiments, the asset relationships produced by a security service are produced such that the cloud computing infrastructure can be easily visualized, as shown in the example, using a visualization software.

This is an example of how the techniques disclosed herein are able to provide visibility of relationships. This visibility of the relationships between assets greatly enhances an interested party's (e.g., an entity or cloud security service provider) ability to uncover attack paths.

The techniques disclosed herein may be used to create graphical representations of cloud computing infrastructure using any chart or graphical format (e.g., relationship tables, adjacency matrix, chord diagram, force-directed graph, tree diagram, Sankey diagram, etc.).

In the example shown, the nodes of the graph represent assets' associated attributes in a cloud computing infrastructure. The edges represent relationships between the assets' associated attributes. The relationship between assets' associated attributes may be used to facilitate defining the relationship between assets.

As illustrated in the example, an asset's associated attribute may have a relationship to another associated attribute of the same asset (e.g., aws-s3api-get-bucket-acl with aws-s3-batch-operation). This may be used to determine relationships between assets through one or more associated attributes where the associated attributes are associated with different assets.

The weights on the edges may represent a probability score for the assets' associated attribute relationships. In some embodiments, the probability score represents the probability that an asset will be attacked from another associated attribute. In some embodiments, the probability score reflects the similarity between the two associated attributes. In some embodiments, the probability score is derived from a similarity score.

The weights on the edges may represent any other metric that may be used to represent relationships between assets such as Jaccard Distance, Manhattan Distance, Euclidean Distance, etc.

In the example shown, the highest probability is between an S3 Bucket™ asset and a Glue™ asset. The graph displays this by showing the relationship between two associated attributes (e.g., the aws-s3api-get-bucket-acl and the aws-glue-data-brew) where the defining attribute of the asset is prepended to the associated attribute. In this example, the associated attributes are the API's “get-bucket-acl” and “data-brew.” The relationship between the S3 Bucket™ asset and the Glue™ asset to their respective API is known because the embeddings of these associated attributes are maintained in the embedding space.

In some embodiments, the graphical representation of this example may be expanded to have n nodes, where each node may have m edges, such that every relationship between every associated attribute is displayed. In some embodiments, the asset relationships generated with the techniques disclosed herein may be used to produce graphical representations that contain shared attributes and/or assets where the edges represent relationships.

An entity may use this visualization to determine attack paths. Entities may also use this visualization as a tool to understand and improve their cloud computing infrastructure. Cloud computing infrastructure may be burdensome to deal with due to its unwieldy nature. For example, product teams may have trouble understanding how each asset in their product's cloud computing infrastructure fits into the whole. For example, the employee who introduced a cloud computing infrastructure asset has left the product team. The graphical representations of the entire cloud computing infrastructure can be used to visually determine which cloud assets are interdependent on which other cloud assets, thus increasing the efficacy of maintaining and building an unwieldy cloud computing infrastructure.

FIG. 11 is an example of training data for use in a fine-tuning procedure in accordance with some embodiments. In some embodiments, training data is represented as a table which includes a plurality of entries. Each entry may be represented as a row comprising one or more columns. In some embodiments, attribute 1 column 1101 comprises an attribute for a first asset and attribute 2 column 1102 comprises an attribute for a second asset. A training query comprises the entry in relationship column 1106 and its associated attributes in attribute 1 column 1101 and attribute 2 column 1102. Relationship score column 1108 comprises the label for the associated training query.

In the example shown, there are five instances of training data, however, there may be a plurality of instances of training data represented by a plurality of rows.

In some embodiments, a plurality of training data is associated with a corresponding corpus. The corresponding corpus comprises a plurality of entries where each entry corresponds to a distinct asset and includes a unique identifier and a textual description. The textual description may reference defining attributes, identifier attributes, and their natural language descriptions. For example, the attribute “aws-ec2-describe-instances” may be associated with information in a corpus corresponding to an EC2™ instance.

A query for use in fine-tuning may comprise of entries in attribute 1 column 1101, attribute 2 column 1102, and relationship column 1106. The query may be associated with a relationship label comprising of the information in relationship score column 1108.

In some embodiments, entries in attribute 1 column 1101 comprise a defining attribute.

A fine-tuning procedure may comprise of fine-tuning a base model with a query (e.g., a query comprising entries in attribute 1 column 1101, attribute 2 column 1102, and relationship column 1106) such that the relationship score in relationship score column 1108 is reflected in the base model.

In some embodiments, a higher score within relationship score column 1108 indicates a stronger relationship between a queried asset (e.g., represented by attribute 1 column 1101) and the corpus asset. Thus, relationship score column 1108 encodes known asset relationships and ensures that the fine-tuning process directs the embedding model to position semantically related assets more closely within the embedding space.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
ingesting metadata associated with a plurality of assets of a cloud computing infrastructure for an entity and a cloud service provider (CSP) specification into a security service;
generating a dataset by collating the metadata associated with each of the plurality of assets and data of the CSP specification(s);
generating embeddings of the dataset using a machine learning model; and
determining relationships between the plurality of assets based at least in part on the embeddings and a similarity score.

2. The method of claim 1, wherein the machine learning model is a text embedding model.

3. The method of claim 1, wherein the machine learning model is a text embedding model, and wherein the machine learning model is fine-tuned using previously defined asset relationships.

4. The method of claim 1, wherein the machine learning model is a text embedding model, and wherein the machine learning model is fine-tuned using previously defined asset relationships wherein fine-tuning further comprises:
preparation of a corpus;
preparation of a plurality of queries; and
preparation of a plurality of relationship labels associated with the plurality of queries.

5. The method of claim 4, wherein the corpus further comprises a plurality of entries where each entry corresponds to a distinct asset and includes a unique identifier and a textual description.

6. The method of claim 4, wherein each query in the plurality of queries represents an asset or asset-related concept for which relevant or related corpus entries are sought.

7. The method of claim 4, wherein each query in the plurality of queries comprises a relevance score.

8. The method of claim 1, wherein determining the relationships between the plurality of assets based at least in part on the embeddings further comprises:
for each asset associated with an embedding space, selecting an asset from a list of assets associated with the embedding space;
for each attribute associated with the asset, selecting an attribute associated with the asset;
determining the associated attribute's relationship to all other associated attributes of all other assets associated with the embedding space; and
determining all asset relationships to all of the other assets based on all relationships between all of the associated attributes.

9. The method of claim 1, wherein the relationships between the plurality of assets is determined using a similarity search that identifies similarities between each asset.

10. The method of claim 1, further comprising identifying an attack path based on the asset relationships and associated attributes of the CSP specification for the entity.

11. The method of claim 1, wherein the relationships between the plurality of assets are determined by relationships between associated attributes.

12. The method of claim 1, further comprising graphically representing the cloud computing infrastructure.

13. The method of claim 1, wherein the dataset comprises one or more asset denotators.

14. The method of claim 1, wherein determining the relationships between the plurality of assets based at least in part on the embeddings further comprises:
determining a set of asset denotators;
determining relationships of the set of asset denotators to all other assets; and
determining a composition of the set of asset denotators' relationships.

15. The method of claim 1, wherein a probability score is derived from the similarity score.

16. The method of claim 1, wherein a probability score is derived from the similarity score, and wherein the relationships are determined at least in part using the probability score.

17. A system, comprising:
a processor configured to:
ingest metadata associated with a plurality of assets of a cloud computing infrastructure for an entity and a CSP specification into a security service;
generate a dataset by collating the metadata associated with each of the plurality of assets and data of the CSP specification(s);
generate embeddings of the dataset using a machine learning model; and
determine relationships between the plurality of assets based at least in part on the embeddings and a similarity score; and
a memory coupled to the processor and configured to provide the processor with instructions.

18. The system of claim 17, wherein the machine learning model is a text embedding model.

19. The system of claim 17, wherein the machine learning model is a text embedding model, and wherein the machine learning model is fine-tuned using previously defined asset relationships.

20. A computer program product embodied in a non-transitory computer readable medium and comprising computer instructions for:
ingesting metadata associated with a plurality of assets of a cloud computing infrastructure for an entity and a cloud service provider (CSP) specification into a security service;
generating a dataset by collating the metadata associated with each of the plurality of assets and data of the CSP specification(s);
generating embeddings of the dataset using a machine learning model; and
determining relationships between the plurality of assets based at least in part on the embeddings and a similarity score.
